(19) United States
(12) Patent Application Publication
(10) Pub. No.: US 2005/0199560 A1
(43) Pub. Date: Sep. 15, 2005

(54) Interchangeable ceramic filter assembly and molten metal processing apparatus including same

(75) Inventor: Adrian Dean Vander Jagt, Essexville, MI (US)

Correspondence Address: BURR & BROWN, PO BOX 7068, SYRACUSE, NY, 13261-7068, US

(73) Assignee: Blasch Precision Ceramics, Inc., Albany, NY (US)

(21) Appl. No.: 11/076,575

(22) Filed: Mar. 9, 2005

Related U.S. Application Data
(60) Provisional application No. 60/552,422, filed on Mar. 11, 2004.

(51) Int. Cl. B01D 29/11

(52) U.S. Cl. 210/791; 210/446

(57) ABSTRACT

An interchangeable ceramic filter assembly is provided, including a ceramic housing tube having at least one inlet, an outlet and a sidewall having an outer surface and an inner surface defining a central chamber. The filter assembly also includes a ceramic filter positioned within the central chamber that provides a barrier between the inlet and the outlet of the ceramic housing tube. The ceramic filter includes a sidewall, an inlet at least on a portion of the sidewall and an outlet. The outer surface of the sidewall faces the inner surface of the ceramic housing tube, and the inner surface of the sidewall defines a central portion of the ceramic filter. A contaminant concentration of molten metal present at the outlet of the ceramic housing tube is less than a contaminant concentration of molten metal present at the inlet of the ceramic housing tube.

### CROSS REFERENCE TO RELATED APPLICATION

This application claims the benefit of U.S. Provisional application Ser. No. 60/552,422, filed Mar. 11, 2004, the entirety of which is incorporated herein by reference.

### FIELD OF THE INVENTION

The present invention generally relates to ceramic filters for filtering or otherwise removing oxides and other contaminants from molten metal to improve the quality of the final products to be made from the molten metal. In particular, the present invention relates to a replaceable, interchangeable ceramic filter assembly for filtering molten metal that can be easily installed in, and removed from, a molten metal processing apparatus for routine maintenance, repair or replacement.

### BACKGROUND OF THE INVENTION

During processing, most molten metals tend to contain some level of impurities or otherwise undesirable contaminants, and are often susceptible to considerable contamination due to atmospheric oxygen exposure during processing. Although there has been progress, and considerable success, in prior efforts to filter such contaminants from molten metal, a major problem associated with removing and replacing clogged filters in existing filtration equipment still exists.

That is, molten metal filters are typically made of porous ceramics that can withstand the temperature and chemical environment of molten metal. Over time, however, the ceramic filters tend to clog due to buildup of the filtered-out contaminants and/or other debris that is removed from the molten metal during filtration. Clogged ceramic filters at elevated molten metal temperatures that are suspended over openings and submerged in molten metal, and clogged ceramic filters that are frozen in place by surface oxides, for example, are very fragile and often break when steps are taken to replace these filters. Even when these filters do not break, however, a considerable amount of contaminants are often spilled back into the melt during the removal and replacement process. This imposes a negative effect on the overall quality of the molten metal end product, and the resultant quality of the final metal products formed therefrom, and may require the implementation of additional process steps to compensate in order to prevent significant yield losses or crippling quality issues.

For example, in order to prevent filter damage and excessive contamination during filter replacement, it is often necessary to halt the molten metal production and drain the molten metal production tanks so that the clogged filter or filters can be removed for cleaning and maintenance or be replaced with a new filter. The production delays associated with the filter replacement process significantly reduce the overall efficiency of the process, and, coupled with the additional processing time, manpower and equipment required implement the additional steps required to prevent filter breakage and further contamination, tend to increase the production costs, and ultimately, the prices of the final metal products.

Further, it is necessary to preheat and prime a ceramic filter assembly in order to allow molten metal to flow through the filter without freezing or plugging with aluminum oxide and to avoid cracking from thermal shock when the ceramic filter is brought into contact with the molten metal at the elevated molten metal temperature. Most molten metals, such as liquid aluminum, flow freely at elevated temperatures, but often these molten metals can react with oxygen and form other compounds that inhibit the free flow of the molten metal. Increased temperatures, such as the preheating temperature of the ceramic filter assembly and the elevated temperatures required to maintain the free flowing state of the molten metal, tend to speed up this chemical process. For example, in the case of molten aluminum processing, liquid aluminum tends to rapidly form an aluminum oxide skin when exposed to oxygen, which can become quite viscous and typically does not flow freely into small pores, such as the inlets in the ceramic filter.

Initially, when a ceramic filter is introduced into molten metal (e.g., liquid aluminum) in a containment vessel of a molten metal processing apparatus, the molten aluminum flows freely into the inlets (e.g., pores) of the ceramic filter. As the molten metal reacts with oxygen present in the pore structure of the ceramic filter, however, more viscous aluminum oxide tends to form, which inhibits the molten aluminum flow through the ceramic filter. As the molten aluminum flows through the ceramic filter and continues to react with the oxygen contained in the pore structure, the amount aluminum oxide that is introduced into the filter increases, and frequently, portions of the ceramic filter will not properly prime due to this, which is a common problem in the industry.

In view of the above, it would be desirable to provide an interchangeable ceramic filter assembly for molten metal filtration applications that can be easily installed in, and removed from, a molten metal processing apparatus for routine maintenance, repair or replacement without damaging the filter or reintroducing undesirable contaminants back into the melt. It would also be desirable to provide a ceramic filter assembly that is preheated such that oxygen is not trapped in the pores of the filter material in order to eliminate the problems associated with priming the filter. Further, it would be desirable to perform the filter replacement process without requiring a significant production delay and preferably without draining the molten metal production vessel.

### SUMMARY OF THE INVENTION

It is an object of the present invention to overcome the drawbacks associated with prior art molten metal filters. In particular, it is an object of the present invention-to provide an interchangeable ceramic filter assembly that is preheated to purge oxygen from the inlets or pore structure of the ceramic filter, and that is easily installed in, and removed from, a molten metal processing apparatus for routine maintenance, repair or replacement without damaging the filter, reintroducing undesirable contaminants back into the melt, or requiring significant production interruptions to facilitate routine filter changes.

According to a first embodiment of the present invention, an interchangeable ceramic filter assembly is provided, including a ceramic housing tube having a first end, an opposed second end, a sidewall connecting the first and second ends, at least one inlet and an outlet. The sidewall of the ceramic housing tube has an outer surface defining an outer peripheral dimension of the ceramic housing tube and an inner surface defining an inner peripheral dimension of the ceramic housing tube and defining a central chamber of the ceramic housing tube. The assembly also includes a ceramic filter positioned within the ceramic housing tube to effectively provide a molten metal barrier between the inlet and the outlet of the ceramic housing tube. The ceramic filter includes a first end, an opposed second end, a sidewall connecting the first and second ends, an inlet at least on a portion of the sidewall and an outlet. The sidewall of the ceramic filter has an outer surface defining an outer peripheral dimension of the ceramic filter and facing the inner surface of the ceramic housing, and an inner surface defining an inner peripheral dimension of the ceramic filter and defining a central portion of the ceramic filter. The outer surface of the ceramic filter sidewall is spaced from the inner surface of the ceramic housing tube by a distance D. The outlet of the ceramic filter is substantially coaxially aligned with the outlet of the ceramic housing tube, and molten metal present at the outlet of the ceramic housing tube has a contaminant concentration that is less than a contaminant concentration of molten metal present at the inlet of the ceramic housing tube

That is, the molten metal introduced into the ceramic housing tube via the inlet or inlets has a contaminant concentration that necessitates filtering. Because the ceramic filter interposed in the central chamber of the ceramic housing tube presents a barrier to the outlet of the ceramic housing tube, and because the molten metal will follow the path of least resistance in its flow toward the outlet, the molten metal must pass through the filter to arrive at the outlet. As the molten metal fills the central portion of the ceramic housing tube, including the distance D between the outer surface of the ceramic filter and the inner surface of the ceramic housing tube, a pressure differential is created that urges the molten metal to pass from the central chamber of the ceramic housing tube into the ceramic filter via the ceramic filter inlet.

The inlet or inlets of the ceramic filter are sized to permit the molten metal to penetrate, and ultimately pass through, the sidewall or other portion of the ceramic filter on which the inlet or inlets are positioned, but at least some of the contaminants are not permitted to fully pass into the central portion of the ceramic filter. It will be understood that the size of the inlet or inlets relative to the size the contaminants present determines the degree to which the contaminants are blocked from entering and/or passing through the inlets. The contaminants are thus effectively trapped out by the filter inlet structure while the molten metal itself passes into the central portion of the ceramic filter, substantially free of at least some degree of the contaminants originally present.

In that manner, the concentration of the contaminants present in the molten metal at the outlet of the ceramic housing tube, which is aligned with the outlet of the ceramic filter, is less than the concentration of contaminants present at the inlet and in the central chamber of the ceramic housing tube. It should also be noted, however, that not only the size of the inlets, but also the quantity and overall distribution of inlets, will play a role in determining the overall effectiveness of the filtering performance of the ceramic filter, including production throughput considerations and controlling the concentration or types of contaminants that are blocked or passed by the ceramic filter.

The distance D provided between the outer surface of the ceramic filter sidewall and the inner surface of the ceramic housing tube can be as little as ¼ inch or less. There is no maximum required clearance between the ceramic filter and the ceramic tube, and thus, no critical upper limit on the dimension D. It will be understood that the clearance required, that is, the required D value, for a particular ceramic filter assembly will depend upon the quantity and size of the inclusions and/or debris that is to be removed from the molten metal, as well as the desired filter throughput speed. For example, larger inclusions require more clearance in order to maintain a free flow of molten metal into the ceramic filter.

The outer and inner peripheral dimensions of the ceramic outer tube are not limited, and can be appropriately selected based on parameters such as the desired through put speed and the head pressure of the molten metal. For example, if the head pressure is high, such as 4 inches of water column or more, a ceramic housing tube having an inner diameter that is as small as 1 inch would still allow transfer of a substantially large quantity of molten metal, particularly if the ceramic filter itself is able to pass a large amount of molten metal (e.g., has a coarse pore size or high permeability). These and other factors affecting the size selection for the ceramic housing tube and ceramic filter will be well understood by those skilled in the art in view of the present disclosure, and the dimensions of the present ceramic filter assembly can be modified accordingly.

One of the benefits provided by the ceramic filter assembly according to the present invention is improved filtering efficiency and throughput which is attributed, at least in part, to the fact that the molten metal is passing through the ceramic filter sidewalls from the outside surfaces thereof into the central portion there of. Since the outer sidewall surface, and potentially a top end surface of the ceramic filter in the present invention offer a larger surface area relative to the inner surface area of the ceramic filter, the volume of molten metal that can be simultaneously filtered is increased. Another benefit is that the effective useful life of the filter, that is, the period of time during which the filter effectively performs before becoming significantly clogged and needs replacing (e.g., the time between required filter assembly replacements), is increased by increasing the effective filtering surfaces.

Moreover, because the ceramic filter is axially and radially surrounded by the ceramic housing tube, the stress of removing the filter assembly from the molten metal bath for replacement will not be placed entirely placed on the potentially brittle. In that manner, the risk of breaking the filter during removal for maintenance or replacement, and thus further disrupting the process and/or reintroducing contaminants back into the molten metal bath, is reduced.

Further, the ceramic filter assembly is provided such that it will be put under a compression, rather than a tension, stress state when molten metal fills the ceramic housing tube. This arrangement improves the overall mechanical strength and performance of the ceramic filter and further reduces the chances of the filter breaking during removal or if there is a sudden influx of molten metal on portions of the ceramic filter structure, as the case may sometimes be in pouring rather than immersion processes.

Suitable materials for ceramic housing tubes according to the present invention include, but are not limited to, silicon carbide, alumina, fused silica, zircon and zirconia, and it should be noted that other additives, such as surfactants (e.g., wetting or non-wetting agents) can also be incorporated with the material composition. Other materials such as magnesia, magnesia-alumina-spinel, silicon nitride, sialon, and treated mullite offer potential applicability for ceramic housing tube materials, as well. The exact composition and characteristics, such as density, pore size, and relative imperviousness to molten metal, of the ceramic filter material are selected and/or tailored on an application dependent basis. For example, in the case of molten aluminum processing, the ceramic housing tube of the filter assembly is preferably made from one of nitride-bonded silicon carbide and oxide bonded silicon carbide including an aluminum non-wetting agent incorporated therein.

According to one aspect of the present invention, the inlet of the ceramic housing tube is positioned proximate the first end thereof. An example of a ceramic housing tube according to this aspect of the present invention would include, but is not limited to, a ceramic tube having an open end providing access to the central chamber thereof. The ceramic housing tube according to this aspect would be useful, for example, in batch processing applications or continuous production situations where the molten metal is poured into the inlet at the top of the ceramic housing tube. Because the molten metal is directly poured into the ceramic housing tube, the concern of introducing floating surface oxide contaminants is not as prominent as it is with immersion filter assembly applications, which are described in more detail below.

According to another aspect of the present invention, the inlet of the ceramic housing tube is positioned on a portion of the sidewall thereof at a location that is lower than a minimum molten metal level within a molten metal processing tank such that the minimum molten metal level is between the inlet and the first end (e.g., top) of the ceramic housing tube. In that manner, when the filter assembly is at least partially immersed in molten metal during processing operations, the molten metal enters the central chamber of the ceramic housing tube via one or more submerged inlet openings on the sidewall of the ceramic housing tube. This arrangement effectively limits the unnecessary introduction of additional surface oxide contaminants typically present near the surface of the molten metal that would otherwise decrease the effective life of the filter (i.e., the filter operation time between replacements) by causing premature clogging.

It is preferred that the inner surface of the second end of the ceramic housing tube includes a seating surface in contact with at least one of the outer surface of the ceramic filter sidewall proximate the second end thereof and an end surface of the second end of the ceramic filter. This seating surface in the second end of the ceramic housing tube provides a stable mating surface for the second end of the ceramic filter, which is held in place by means such as a heat treated high temperature refractory adhesive, for example. According to one aspect, it is preferred that the seating surface includes a shoulder portion that contacts a portion of the outer surface of the sidewall of the ceramic filter at the second end thereof to provide radial stability and further reinforce the integrity of the junction between the ceramic filter and the ceramic housing tube.

The stability of the mating junction between the ceramic housing tube and the ceramic filter positioned there in is important for several reasons. For example, the quality of the junction between the ceramic housing tube and the ceramic filter at the seating surface must be high in order to prevent contaminated metal from leaking through the junction instead of passing through the filter as intended. Mechanically speaking, a stable seating relationship further improves the radial stability, and to some degree, the axial stability of the ceramic filter within the ceramic housing tube. This also contributes to a high quality junction by reducing the chances of tipping or separation due to external physical disturbances or uneven or unexpected forces exerted by the molten metal within the filter assembly.

Suitable materials for the ceramic filters according to the present invention include, but are not limited to, silicon carbide, alumina, zircon and zirconia. Other materials that offer potential applicability for use as the ceramic filter material include, for example, silicon nitride, sialon, and mullite. While certain materials, such as silicon carbide or zirconia are particularly preferred, the exact composition and characteristics, such as pore size and porosity of the ceramic filter material, are tailored on an application dependent basis. For example, in the case of molten aluminum processing, at least the sidewalls of the ceramic filters are preferably made from one of the above-noted preferred materials having a sufficient porosity to prevent typical contaminants, such as various oxides and refractory inclusions, from fully passing through the ceramic filter inlets, which, in this case, are actually defined by the pores and pore structure of the ceramic filter material.

As mentioned above, the ceramic filter includes an inlet at least on a portion of the sidewall thereof. The ceramic filter further can include an inlet at least on a portion of the first end thereof, as well. That is, an upper surface at the top of the filter (e.g., the terminal portion of the first end) can also include at least one inlet that permits molten metal to pass into the central portion of the ceramic filter while blocking the passage of contaminants therethrough. For example, even in preferred situations where the entire first end of the ceramic filter is covered, that end covering can be made of a molten metal permeable material having pores defining one or more inlets.

According to one aspect of the present invention, the ceramic filter includes at least one of a first end cap fastened to the first end of the ceramic filter and a second end cap fastened to the second end of the ceramic filter. Preferably, the first end cap completely covers the terminal portion of the first end of the ceramic filter, as mentioned above. The first end cap also preferably includes means for mechanically stabilizing the ceramic filter within the ceramic housing tube, and the first end cap can also include an inlet at least on a portion thereof. The second end cap preferably includes an opening that is coaxially aligned with the outlet of the ceramic filter and the outlet of the ceramic housing tube. It is also preferred that the lower surface of the second end cap is configured to be securely seated at the appropriate position in conjunction with the inner surface of the second end of the ceramic housing tube.

The first and second end caps can be made from the same molten metal permeable material as that of the ceramic housing tube, or from another similar material that is less permeable or even substantially impermeable to molten metal, as long as the material as compatible with the materials of the ceramic filter and ceramic housing tube in terms of chemical stability and thermal expansion behavior, for example. Suitable examples of metal-impermeable materials for the ends caps vary widely depending upon the particular molten metal application. In the case of molten aluminum processing, however, suitable examples include, but are not limited to, nitride bonded silicon carbide and oxide bonded silicon carbide having a suitable aluminum non-wetting agent incorporated therein. While one example of a suitable aluminum non-wetting agent includes boron nitride, other suitable aluminum non-wetting agents are known to those skilled in the art.

In addition, it should also be noted that at least the first end cap can be made from a material that is either the same as that of the ceramic filter sidewall material, or another similar material that is at least partially permeable, or even substantially permeable to molten metal, but that is not permeable to the inclusions or contaminants therein. Suitable examples of molten metal-permeable, substantially inclusion or contaminant-impermeable materials for the ends caps include, but are not limited to, silicon carbide, alumina, zircon and zirconia. In the case of molten aluminum processing, silicon carbide and zirconia are particularly preferred.

According to a second embodiment of the present invention, a molten metal processing apparatus is provided, including a molten metal containment vessel adapted to maintain a minimum molten metal level and including at least a first compartment and a second compartment separated from the first compartment. An interchangeable, removable ceramic filter assembly, such as the filter assembly described above with respect to the first embodiment of the present invention, is provided and positioned to separate at least a portion of the first compartment from the second compartment. The inlet of the ceramic housing tube of the filter assembly is in communication with the first compartment, and the outlet of the ceramic housing tube is in communication with the second compartment at least via a porthole in a port provided between the first and second compartments, and the concentration of contaminants that is present in the molten metal in the second compartment is less than the molten metal contamination concentration in the first compartment.

According to the above second embodiment, at least a portion of the filter assembly effectively defines at least a portion of a molten metal barrier that separates the first and second compartments of the vessel. In order for molten metal to pass from the first compartment into the second compartment, the molten metal must pass through at least a portion of the ceramic filter assembly, whereby at least some of the contaminants present in the molten metal in the first compartment are trapped out, before passing through the port between compartments via the porthole. In that manner, the molten metal that is allowed to pass from the first compartment to the second compartment via the filter assembly and porthole contains a lower concentration of contaminants then the pre-filtered molten metal in the first compartment.

It should be noted that external mechanical stabilization means, such as a clamp, for example, can be applied to the filter assembly, for example, at the first end of the ceramic housing tube, to provide axial stabilization of the seated filter assembly within the vessel. In this case, it is preferred that this mechanical stabilizing means include a quick-release type feature such that the stabilizing force can be quickly and easily disengaged when the ceramic filter assembly needs to be removed form the vessel for maintenance or replacement. Examples of suitable stabilizing means include, but are not limited to, toggle clamps and bolted joints.

According to one aspect of this embodiment of the present invention, it is preferred that at least a portion of the port between the compartments includes a port seating surface proximate, and preferably surrounding, the porthole. It is also preferred that the seating surface has a contour that is complementary to a surface contour of the outer surface of the second end of the ceramic housing tube proximate the outlet. It is important that the contour of the port seating surface corresponds to the contour of the outer surface of the second end of the ceramic housing tube, and in some cases, including at least a portion of the outer surface of the sidewall of the ceramic housing tube at the second end thereof, to facilitate easy insertion into the vessel when the ceramic filter assembly is installed.

That is, in many cases, the first compartment of the vessel will be filled with molten metal through which the filter assembly must be guided and aligned during installation so that the outlet of the ceramic housing corresponds to the port and porthole, and such that the junction therebetween will ultimately be substantially impervious to molten metal leaks. By providing complimentary seating surfaces, proper alignment and stable positioning of the ceramic filter assembly within the vessel can be achieved with considerable ease. To further improve the ease of installing a replacement filter assembly, it is particularly preferred that the contour of the outer surface of the second end of the ceramic housing tube is least hemispherical. In that manner, a greater degree of radial play is provided, and proper alignment between the ceramic filter assembly and the port of the vessel can be easily achieved with few required axial and radial adjustments and without the need for time consuming and labor intensive precision alignment steps.

For example, as mentioned above, once the ceramic filter assembly is positioned in the appropriate location, guided thereby thanks to the complimentary surface contours and port seating surface, the outlet of the ceramic filter assembly (including the outlets of the ceramic housing tube and the ceramic filter) is aligned with the porthole to provide a junction that is stable and secure. The quality and integrity of this junction is sufficient to prevent contaminated molten metal in the first compartment from leaking past the junction and into the porthole between the outer surface of the second end of the ceramic housing tube and the port on which it is seated.

According to another aspect of this embodiment of the present invention, at least a first end cap is provided to the ceramic filter. According to yet another aspect, the first end cap preferably comprises means for mechanically stabilizing at least one of (i) the ceramic filter within the ceramic housing tube and (ii) the filter assembly within the vessel. For example, according to one aspect, the first end cap includes means for applying axial pressure to the ceramic filter assembly within the vessel to better secure the junction at the port seating surface. In addition, or alternatively, the first end cap can include means for stabilizing the ceramic filter within the ceramic housing tube, such as a plurality of radially extending tabs that protrude from the periphery of the first end cap. In this case, it is preferred that the tabs span the distance D within the central chamber and contact portions of the inner surface of the ceramic housing tube to thereby hold the ceramic filter in a substantially fixed position, even in situations where the end cap is susceptible to considerable forces from the introduction of top-poured molten metal in such applications. In fact, this type of radial stabilization in particularly preferred in top pouring applications for this very reason.

According to another embodiment of the present invention, a method is provided for determining a replacement time and for replacing an interchangeable filter assembly according to any one of the above aspects of the first embodiment of the present invention in a molten metal processing apparatus according to any one of the aspects of the second embodiment of the present invention. Among other steps, the method includes the steps of monitoring the molten metal level within the first and the second compartments of the vessel as molten metal in the second compartment is consumed and replenished with molten metal from the first compartment via the filter assembly, and determining that the molten metal level in the first compartment exceeds the molten metal level in the second compartment by a predetermined amount. The predetermined amount corresponding the molten metal level differential between the first and second compartments is typically measured in terms of approximated inches, and is preferably in a range of approximately 1 to 3 inches. The method also includes the steps of stopping consumption of the molten metal from the second compartment and allowing the molten metal level in the second compartment to equalize with the molten metal level in the first compartment before removing the filter assembly from the vessel. The method further includes providing a replacement ceramic filter assembly comprising a ceramic filter assembly according to any of the above aspects of the first embodiment of the present invention that has been preheated to a temperature in a range of 1450 to 1500° F. in a substantially oxygen-free atmosphere, such as an inert gas atmosphere, to purge any oxygen from the pores or inlets of the ceramic filter material, sealing at least the upper end of the replacement ceramic filter assembly with an end cover, and optionally sealing the lower end of the replacement ceramic filter assembly with an end plug, to prevent oxygen from being introduced into the central chamber of the ceramic housing tube and the ceramic filter material during transfer from the preheating atmosphere to the molten metal processing apparatus. The end plug (if provided) is removed just before positioning and introducing the replacement ceramic filter assembly into the vessel such that the outlet of the ceramic housing tube is aligned with and in communication with the porthole of the port, providing mechanical stabilization for the replacement ceramic filter assembly within the vessel. The method also includes the steps of priming the filter and resuming consumption of the molten metal in the second compartment as the molten metal is replenished with molten metal from the first compartment via the replacement ceramic filter assembly.

### BRIEF DESCRIPTION OF THE DRAWINGS

For a better understanding of the nature and object of the present invention, reference should be made to the following detailed description of a preferred mode of practicing the invention, read in connection with the accompanying drawings, in which:

FIG. 1 is a cross-sectional front view of a ceramic filter assembly according to one aspect of the present invention;

FIG. 2 is a cross-sectional front view of a ceramic filter assembly according to another aspect of the present invention;

FIGS. 3A-B show a ceramic filter according to one aspect of the present invention, wherein FIG. 3A is a cross-sectional front view of the ceramic filter and FIG. 3B is a top view of the ceramic filter;

FIG. 4 is a cross-sectional front view of a ceramic filter assembly according to another aspect of the present invention including the ceramic filter shown in FIGS. 3A-B;

FIG. 5 is a cross-sectional front view of a ceramic filter assembly according to another aspect of the present invention;

FIG. 6 is a partial cross-sectional view of a molten metal processing apparatus according to one embodiment of the present invention including the ceramic filter assembly shown in FIG. 5; and

FIG. 7 is a partial cross-sectional view of another molten metal processing apparatus according to the present invention including the ceramic filter assembly shown in FIG. 5.

### DETAILED DESCRIPTION OF THE INVENTION

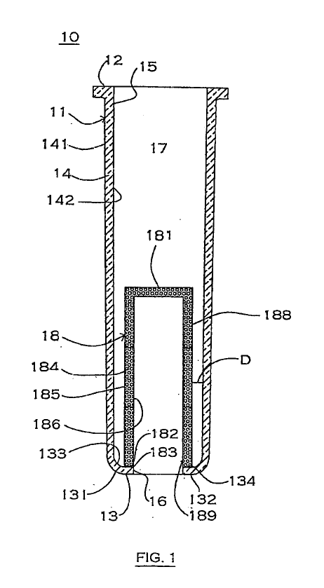

As mentioned above, the present invention provides an interchangeable ceramic filter assembly that is particularly useful in molten metal processing applications, that can be easily removed and accurately replaced without damaging the filter assembly, without causing contaminants to be reintroduced into the melt and without otherwise causing significant production delays. Filter assemblies according to various aspects of the present invention, and filters therefor, are shown in FIGS. 1-5.

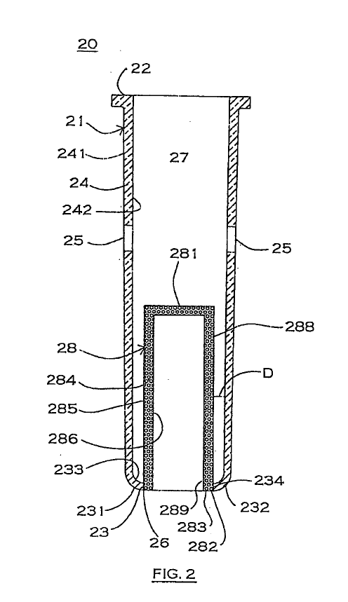

FIGS. 1 and 2 are cross-sectional front views of ceramic filter assemblies 10 and 20, respectively, according to different aspects of the present invention. Due to the substantial similarities between the ceramic filter assemblies 10 and 20, like components and features will be described together.

Ceramic filter assemblies 10 and 20 respectively include ceramic housing tubes 11, 21 and ceramic filters 18, 28 located within respective central chambers 17, 27 of the ceramic housing tubes 11, 21. Ceramic housing tubes 11, 21 each have a respective first end 12, 22, which is shown as an upper or top end in FIGS. 1 and 2, an opposed second end 13, 23, which is shown as a lower or bottom end in FIGS. 1 and 2, and a respective sidewall 14, 24 connecting the respective first and second ends. The respective sidewall portions 14, 24 each have an outer surface 131, 231 and an inner surface 133, 233 defining the respective central chambers 17, 27.

As shown in the Figures, the sidewall portions 14, 24 of the respective ceramic housing tubes are formed to have a substantially cylindrical configuration. It should be noted, however, that the shape of the sidewall configuration is not necessarily limited to cylindrical, and those skilled in the art could easily modify the shape and instead form the ceramic filter sidewalls to assume an elliptical cylinder shape, a conical or frustroconical shape, or even a square or other polygonal shape, including, but not limited to, hexagonal, octagonal or triangular shapes, using any suitable, conventionally known ceramic forming technique. In order to minimize the potential for stress induced defects or failures during production and use of the ceramic filters, however, it is preferred that the shape of the ceramic filter is substantially cylindrical, at least partially conical, or otherwise rounded to reduce the development of stress concentration points at angular corners.

Ceramic housing tube 11 shown in FIG. 1 includes an inlet 15 provided at the first end 12 thereof to provide access to the central chamber 17, and an outlet 16 provided at the second end 13 thereof. Ceramic housing tube 21 shown in FIG. 2 includes inlets 25 provided on opposing locations of sidewall 24, passing from the outer surface 231 to the inner surface 233 thereof, to provide access to the central chamber 27. It should be noted, however, that ceramic housing tube 21 also has an inlet proximate the first end 22 thereof, similar to the inlet 15 in ceramic housing tube 11 shown in FIG. 1, by virtue of the fact that the first end 22 of ceramic housing tube 21 is open to the atmosphere (i.e., not sealed off or otherwise closed). Further, an outlet 26 is provided at the second end 23 of ceramic housing tube 21.

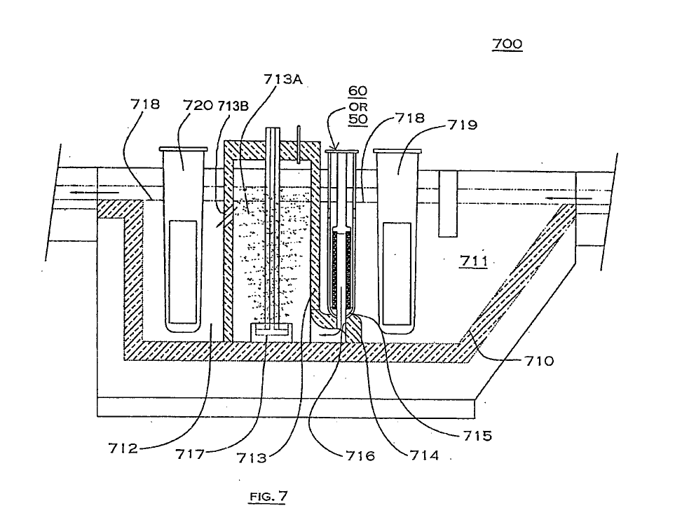

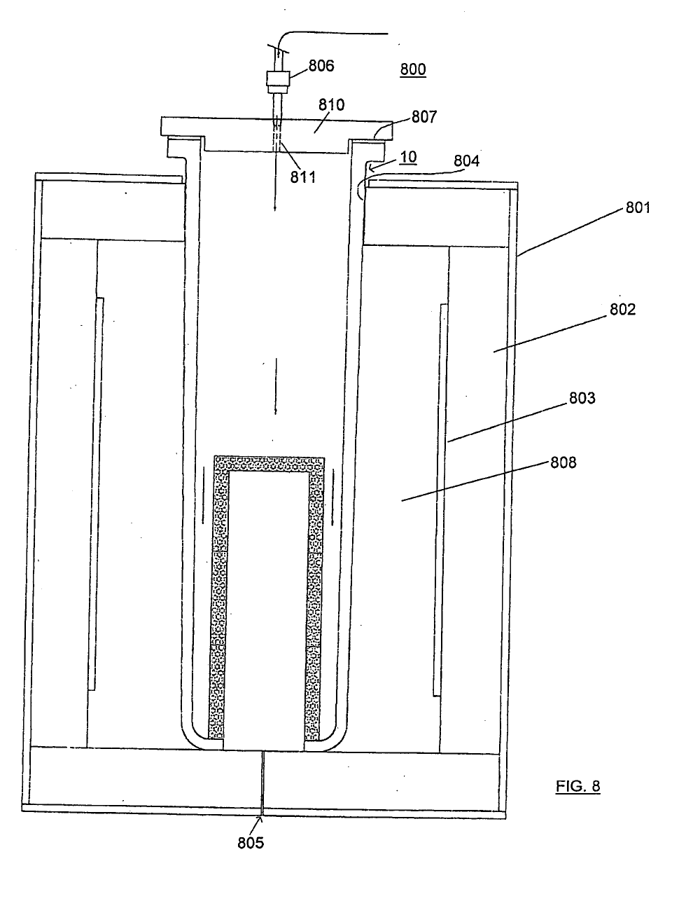

In view of the above, it will be understood that ceramic housing tube 11 in FIG. 1 is suited for molten metal pouring applications, where molten metal is poured into the central chamber 17 via inlet 15, whereas ceramic housing tube 21 is better suited for immersion applications, where the ceramic filter assembly 20 is immersed in a molten metal bath which gains access to the central chamber 27 via the inlets 25 in sidewall 24. In immersion applications, it is preferred that the inlets 25 are positioned on the sidewall 24 such that the inlets 25 themselves will be immersed, that is, located below the minimum molten metal level, when the ceramic filter assembly 20 is immersed in molten metal. Preferably, the inlets 25 are located a distance of 3 to 6 inches below the molten metal surface level. This is also discussed in more detail below in connection with FIGS. 6 and 7.

The respective ceramic filters 18, 28 of ceramic filter assemblies 10 and 20 are positioned within the respective central chambers 17, 27 of ceramic housing tubes 11, 21 proximate the second ends 13, 23 thereof. It can be seen that the position of each ceramic filter 18, 28 within the respective central chambers 17, 27 effectively provides a barrier between the respective inlets 15, 25 and outlets 16, 26 of ceramic housing tubes 11, 21. In that manner, molten metal present within the respective central chambers 17, 27 must therefore pass through filters 18, 28 in order to exit the ceramic filter assemblies 10, 20 via the respective outlets 16, 26.

Ceramic filters 18, 28 each respectively include a first end 181, 281, an opposed second end 182, 282 and respective sidewall portions 184, 284 extending between the respective first and second ends. As shown in FIGS. 1 and 2, the first ends 181, 281 of ceramic filters 18, 28 represent a terminal end surface (e.g., top surface) of the respective filters that is either integral with or otherwise made of the same material as the sidewalls 184, 284. On the other hand, the respective second ends 182, 282 of ceramic filters 18, 28 are open and, as shown, define at least a portion of the respective outlets 189, 289 of ceramic filters 18, 28.

Ceramic filters 18, 28 also include at least one inlet 188, 288 at least on a portion of the respective sidewalls 184, 284 thereof. That is, as shown in FIGS. 1 and 2, at least the sidewalls 184, 284 of ceramic filters 18, 28 include inlets 188, 288, in this case, by virtue of the fact that at least sidewalls 184, 284 are made of a refractory ceramic material having a sufficient porosity to effectively pass molten metal while preventing contaminants such as surface oxides and debris from thereby penetrating the respective sidewalls 184, 284. In that manner, the pore structure itself of sidewalls 184, 284 provides not only at least one inlet 188, 288, but a plurality of inlets 188, 288 that comprise at least a portion of the network pore structure of the respective ceramic filters 18, 28 that is preferably dispersed substantially over entirety of the respective outer surfaces 185, 285 of ceramic filters 18 and 28, as shown.

In addition, the first ends 181, 281 of ceramic filters 18, 28 shown in FIGS. 1 and 2 also include at least one inlet 188, 288, but more specifically, a plurality of inlets 188, 288 comprising another portion of the network pore structure of the respective filters 18, 28 that is preferably dispersed substantially over entirety of the respective first ends 181, 281 of filters 18 and 28, as shown. Indeed, it will be understood that inlets 188, 288 actually represent pores of the ceramic filter material and are distributed substantially over the entire outer surface of each ceramic filter 18, 28, including the outer surfaces 185, 285 of sidewalls 184, 284 and the respective outer surfaces of the first ends 181, 281. In that manner, the entire outer surface of each filter 18, 28 can be effectively utilized in filtration operations, which improves throughput and speeds the processing efficiency of providing molten metal from which the contaminants have been removed.

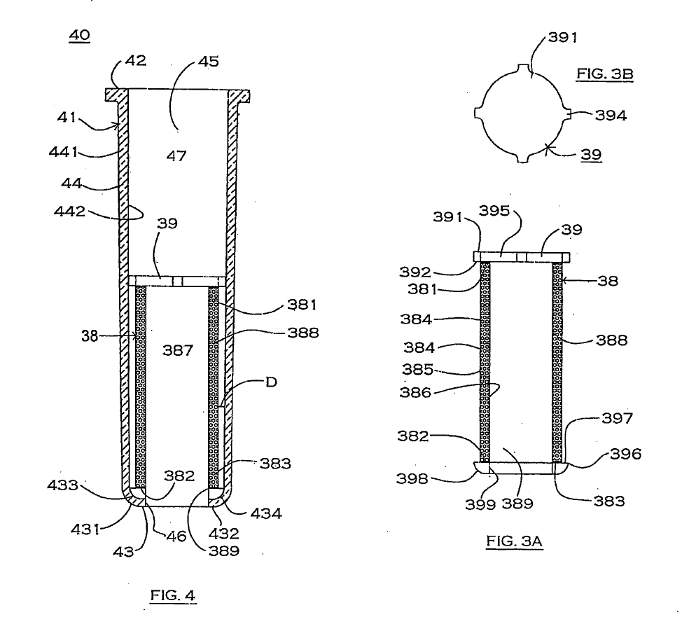

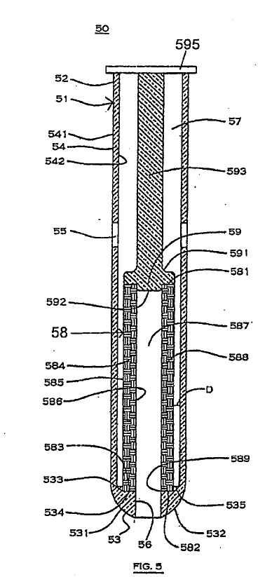

It will also be understood, however, that the ceramic filters used in the ceramic filter assemblies according to the present invention need not be a single, unitary or otherwise integral ceramic filter body, such as the ceramic filter structures 18, 28 shown in FIGS. 1 and 2, but can also include portions that are comprised of different materials. In that manner, some portions of the ceramic filters can be made permeable to molten metal while other portions are not necessarily permeable to the molten metal. It should be noted that, in some cases, even the otherwise impermeable portions of the ceramic filter may instead offer another type of inlet configuration (other than being made partially or substantially entirely of a porous filtering body), or may not offer any substantial inlet configuration at all. An example of another ceramic filter structure that is not necessarily made entirely of a unitary porous filter body is shown and described in more detail below in connection with FIGS. 3A, 3B and 4.

To provide ceramic filter assemblies 10 and 20, the respective second ends 182, 282 of ceramic filters 18, 28 are positioned within the central chambers 17, 27 of ceramic housing tubes 11, 21 such that the respective filter outlets 189, 289 are substantially coaxially aligned with the respective outlets of ceramic housing tubes 11, 21. It is preferred that the second ends 182, 282 of the ceramic filters 18 and 28 are secured to a portion of the inner surface 133, 233 of the second ends 13, 23 of the ceramic housing tubes 11, 21. This can be accomplished in a variety of ways, only some of which are shown in FIGS. 1-6.

For example, as shown in FIG. 1, ceramic filter 18 is positioned such that the outlet 189 is substantially coaxially aligned with the outlet 16 of ceramic housing tube 11, and the outer surface 183 of the second end 182 is joined to the seating area 134 of the inner surface 133 of the second end 13 of ceramic housing tube 11. This junction can be secured by any suitable means, examples of which include, but are not limited to, adhesives, heat treatment, a combination of adhesives and heat treatment, mechanical couplings and the like. As shown, the inner dimension of the central portion 187 of ceramic filter 18 at outlet 189 substantially corresponds to the dimension of outlet 16 of ceramic housing tube 11. Further, the inner surface 186 of sidewall 184, at least at the second end 182 of ceramic filter 18, is substantially flush with an inner sidewall surface defining outlet 16 in the second end 13 of the ceramic housing tube 11.

In FIG. 2, ceramic filter 28 is positioned such that outlet 289 is substantially coaxially aligned with outlet 26 of ceramic housing tube 21, and a portion of the outer surface 284 of sidewall 24 at the second end 282 of ceramic filter 28 is joined to a portion of the inner surface 233 of the second end 23 that comprises a sidewall portion defining outlet 26 of ceramic housing tube 21. As shown, the outer surface 283 (e.g., the lower or bottom surface) of the second end 282 of ceramic filter 28 is substantially flush with the outer surface (e.g., the lower or bottom surface) 231 of the second end 23 of ceramic housing tube 21. Although this junction can be at least partially facilitated by a press-fit type or close-fit relationship, where the outer dimension of the second end of ceramic filter 28 is substantially the same as, but preferably slightly less than, the inner dimension of outlet 26, it is preferred that the junction is reinforced with an adhesive or other suitable joining means, such as those described above.

In both of the aspects shown in FIGS. 1 and 2, however, it is important to note that the junctions between the respective ceramic filters 18, 28 and ceramic housing tubes 11, 21 are impermeable to molten metal. That is, these junctions must be sufficiently secure enough to prevent contaminated molten metal from seeping or leaking through the junction and out the outlet 46 without otherwise being filtered.

An example of a ceramic filter assembly 40 according to another aspect of the present invention is shown in FIGS. 3A, 3B and 4. Ceramic filter assembly 40 includes a ceramic housing tube 41 that is substantially the same as ceramic housing tube 11 shown in FIG. 1. Similar reference numbers denote like features (with the exception of the first digit which corresponds to the Figure number). It should be noted, however, that although ceramic housing tubes 11 and 41 are shown having top pouring-type inlets at the respective first ends 12, 42 thereof, these ceramic housing tubes could easily be modified or substituted with ceramic filter tubes having inlets provided on the sidewalls thereof rather than only at the first ends, such as ceramic filter tube 21 shown in FIG. 2.

Ceramic filter assembly 40 shown in FIG. 4 includes a ceramic filter 38 having a structure that, unlike ceramic filters 18 and 28 shown in FIGS. 1 and 2, is not necessarily made entirely of a porous filter body having a substantially unitary composition. For example, as shown in FIG. 3A, ceramic filter 38 includes a first end cap 39 positioned at the first end 381 to cover the terminal end of central portion 387 that would otherwise be open. The main outer peripheral shape of end cap 39 substantially corresponds to the outer peripheral end-view shape of the sidewall 384 configuration, which, as shown, is substantially circular when the sidewall configuration is substantially cylindrical (as in FIG. 4). Further, the outer dimension (e.g., outer diameter) of the main outer peripheral shape of end cap 39 substantially corresponds to the outer peripheral dimension (e.g., inner diameter) of the outer surface 385 of sidewall 384, as shown in FIGS. 3A and 3B.

Ceramic filter 38 also includes a second end cap 396 positioned at the second end 382 and having an outlet 399 that is coaxially aligned with the outlet 389 of ceramic filter 38. The main outer peripheral shape of the second end cap 396 substantially corresponds to the outer peripheral end-view shape of the sidewall 384 configuration, and the outer dimension (e.g., outer diameter) of the main outer peripheral shape of end cap 396 can exceed or substantially correspond to the outer peripheral dimension (e.g., outer diameter) of the outer surface 385 of sidewall 384. As shown, the outer diameter of end cap 396 is greater than the outer diameter of sidewall 384. In this case, it is preferred that the outer peripheral edge of end cap 396 extend a distance beyond the outer surface 385 of sidewall 384 by a distance that is substantially equal to D (i.e., the distance between the outer surface of the sidewall of the ceramic filter and the inner surface of the sidewall of the ceramic housing tube). That is, it is preferred that the outer diameter of end cap 396 substantially corresponds to, but is slightly less than, the inner diameter of ceramic housing tube 41.

As mentioned above, first end cap 39 can be made of a material that is not permeable to molten metal, that is chemically resistant (e.g., corrosion resistant, non-reactive, etc.) to the particular molten metal to be filtered, that is thermally resistant to the high temperatures at which the molten metal process is maintained, and that is compatible with the material of the sidewall 384 of filter 38, at least in terms of chemical reactivity and thermal expansion behavior. While the material of the first end cap 39 itself is not necessarily permeable (e.g., substantially impervious) to molten metal in this case, it should be noted that other types of inlets, such as a through hole or porthole, for example, could also be provided on the end cap 39, so long as the size of such inlets would effectively pass the molten metal but not the contaminants to be filtered out.

On the other hand, the first end cap 39 could instead be made of a material which itself is partially or substantially permeable to molten metal (but not to the contaminants) and which has a pore structure that defines the inlets. This material can be the same as, or different from but compatible with, the sidewall 384 material of ceramic filter 38, at least in terms of chemical reactivity and thermal expansion behavior. It should be noted, however, that if the first end cap 39 is made of a material which itself is at least semi-permeable to molten metal (but not to the contaminants) but which does not itself provide inlets by virtue of porosity features, other inlets could be provided on the end cap 39, as mentioned above.

Likewise, the second end cap 396 could also be made from the various materials described above in connection with the first end cap 39. It is preferred, however, that the second end cap 396 is made from a material that is not substantially permeable (e.g., substantially impervious) to the molten metal, that is chemically resistant (e.g., corrosion resistant, non-reactive, etc.) to the particular molten metal to be filtered, that is thermally resistant to the high temperatures at which the molten metal process is maintained, and that is compatible with the sidewall 384 material of ceramic filter 38, at least in terms of chemical reactivity and thermal expansion behavior.

Before ceramic filter 38 is joined with ceramic housing tube 41 to form ceramic filter assembly 40, the first and second end caps 39 and 396 are joined to the respective end portions of sidewall 384 to assemble ceramic filter 38. The junction can be provided using any suitable means, including, but not limited to, an adhesive that is compatible with the materials of the sidewall 384 and end caps 39, 396, an adhesive and heat treatment, heat treatment, mechanical connecting means and the like. It is preferred that an adhesive is provided between the lower surface 392 of first end cap 39 and the uppermost outer surface of the first end 381 of ceramic filter 38. It is also preferred that an adhesive is likewise provided between the upper surface 397 of the second end cap 396 and the lowermost outer surface 383 of ceramic filter 38, after first aligning end cap 396 such that the outlet 399 is substantially coaxially aligned with the outlet 389 of ceramic filter 38.

While any suitable adhesive can be used, it is preferred that the adhesive is temperature-resistant and compatible with the materials of ceramic filter 38 and ceramic housing tube 41, at least in terms of chemical reactivity and thermal expansion behavior characteristics. Examples of such adhesives include, but are not limited to, calcium aluminate based cements/mortars and phosphate based cements/mortars. In the case of molten aluminum processing, phosphate based cements/mortars are preferred.

After the respective pieces are joined with the adhesive, the assembled ceramic filter 38 is subjected to a heat treatment, for example, to improve the integrity of, and further secure the bond between, the respective pieces of the ceramic filter. The ceramic filter 38, thus assembled, is positioned within the central chamber 47 of ceramic housing tube 41 in a similar manner as that described above in connection with FIGS. 1 and 2. There are, however, some important structural differences associated with joining ceramic filter 38 and ceramic housing tube 41 that are imparted by the various structures of the respective end caps 39, 396.

For example, as shown in FIG. 3B, a plurality of tabs 394 are provided radially extending from, and distributed about the outer periphery of, end cap 39. These tabs 394 extend a distance in the radial direction to sufficient span the space D between the outer surface 385 of sidewall 384 of ceramic filter 38 and the inner surface 442 of ceramic housing tube 41. That is, the overall outer peripheral dimension, in this case the overall outer diameter, of end cap 39, defined between the terminal ends of two radially opposed tabs 394, substantially corresponds to the inner peripheral dimension, in this case the inner diameter, of ceramic housing tube 41. In that manner, when ceramic filter 38 is positioned within ceramic housing tube 41 as shown in FIG. 3A, tabs 394 contact a portion of the inner surface 442 within the central chamber 47 of ceramic housing tube 41 to act as mechanical stabilizers and provide at least radial support for ceramic filter 38 of ceramic filter assembly 40.

Because tabs 394 are spaced a distance from one another about the outer peripheral shape of end cap 39, as shown in FIG. 3B, a plurality of slots 395 are defined between respective portions of the outer sidewall surface of the peripheral edge of end cap 39 (circumferentially between tabs 394) and the inner surface 442 of ceramic housing tube 41. Slots 395 provide a passage for molten metal to travel between inlet 45 and outlet 46, since the direct path between inlet 45 and outlet 46 is otherwise axially (vertically as shown) blocked by the position of ceramic filter 38. The specific configurations of tabs 394 and slots 395 are not limited to the configurations shown in FIGS. 3A, 3B and 4, and any configuration can be employed so long as sufficient support for ceramic tube 38 is maintained and so long as a sufficient amount of molten metal can be fed through the slots 395 during the molten metal production process.

Mechanical stabilization for ceramic filter 38 within ceramic filter assembly 40 can also be provided by at least a portion of end cap 396 when the outer peripheral edge of end cap 396 is formed to extend beyond the outer surface 385 of sidewall 384 by a distance that is substantially equal to D (i.e., the distance between the outer surface of the sidewall of the ceramic filter and the inner surface of the sidewall of the ceramic housing tube), as described above. The seating-type mechanical stabilization provided by the outer peripheral portions of end cap 396, however, can be both radial and axial in view of its position on seating surface 434 at the second end 43 of ceramic housing tube 41.

That is, as shown in FIG. 4, outlet 399 of the second end cap 396 is aligned with the outlet 46 of ceramic housing tube 41, and the lowermost outer surface 398 of the second cap 396 is positioned on seating surface 434 at the second end 43 of ceramic housing tube 40. An adhesive or joining means is preferably interposed at the junction. This adhesive can be the same as, or different from, adhesive means used to assemble the respective end caps to ceramic filter 38 itself, and similar characteristics are required of this adhesive means, as well. As mentioned above in connection with ceramic filter assemblies 10 and 20, it is important that the junction between ceramic filter 38 and ceramic housing tube 41 is sufficient to prevent contaminated molten metal from seeping or leaking through the junction and out the outlet 46 without otherwise being filtered.

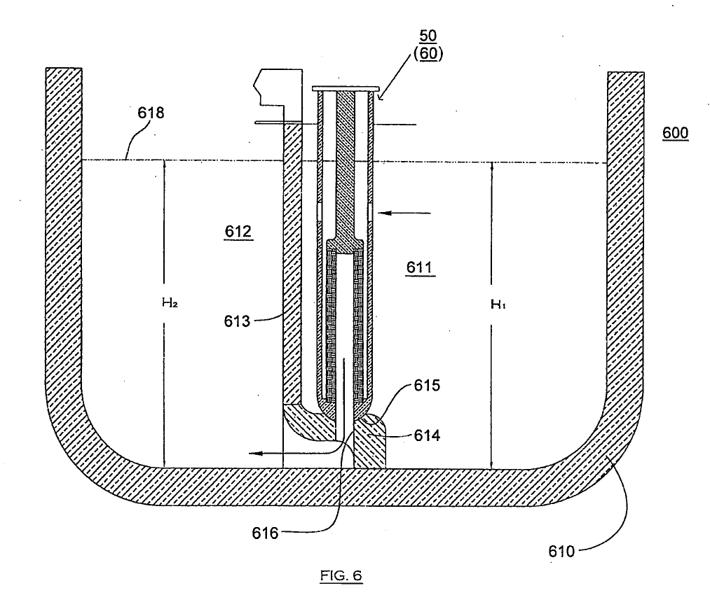

An example of a filter assembly 50, 60 according to yet another aspect of the present invention is shown in FIGS. 5-7. Ceramic filter assembly 50 shown in FIG. 5 and 60 shown in FIG. 6 are the same, and include a ceramic housing tube 51 that is substantially similar to ceramic housing tube 21 shown in FIG. 2, with a few exceptions. For example, specific structural features, shown in FIG. 5, for example, are additionally provided to the second end 53 of ceramic housing tube 51, and the first end 52 is at least partially closed off by at least a portion of end cap 59 provided on ceramic filter 58, as shown in FIGS. 5-7 and described in more detail below.

Ceramic filter assembly 50 also includes ceramic filter 58 having a sidewall 54 that is substantially the same as that shown and described in connection with ceramic filter 38 in FIG. 3A. Ceramic filter 58 also includes end cap 59, as mentioned above, having mechanical stabilizing means (e.g., shaft 593), but mechanical stabilizing means 593 is significantly different from the mechanical stabilization means (e.g., radially extending tabs) of the first end cap 39 shown in FIGS. 3A, 3B and 4.

The second end 53 of ceramic housing tube 51 includes several unique structural features that are not shown in the aspects of the present invention depicted in FIGS. 1-4. For example, the outer surface 531 of the second end 53 is provided with substantially a contoured shape at the bottom portion thereof. As shown in FIG. 5, this contour shape is substantially hemispherical, and is substantially more rounded than the contour shapes imparted to the respective outer surfaces of the second ends of ceramic housing tubes 11, 21 and 41 shown in FIGS. 1, 2 and 4. The substantially hemispherical contour shape of the outer surface 531 enables ceramic filter assembly 50 to be easily positioned with respect to a corresponding port and porthole in a molten metal processing apparatus, as discussed in more detail below in connection with FIGS. 6 and 7.

Further, inner surface 533 of the second end 53 of ceramic housing tube 51 is also significantly different from those described above. For example, while the inner surface 533 of the second end 53 includes seating surface 534 to provide a stable junction surface for the second end of ceramic filter 58, seating surface 534 also includes a shoulder portion 535, for example, a step portion or an annular ridge that surrounds an annular groove in the seating surface 534. That is, as shown, shoulder portion 535 is essentially an outer peripheral boundary of seating surface 534 and comprises a radial (or lateral) stop that inhibits side-to-side movement of the second end 582 of ceramic filter 58 positioned within ceramic housing tube 51. In cases where shoulder portion 535 is an annular ridge, that is, where shoulder portion 535 surrounds a recessed portion of seating surface 534 (i.e., an annular groove), as shown in FIG. 5, the axially extending sidewall defining the outer diameter of the annular groove also defines the inner diameter of the annular ridge where the step-like surface profile exists.

The outer diameter of the annular groove of seating surface 534, or the inner diameter of the annular ridge, substantially corresponds to the outer diameter of the sidewall 584 of ceramic filter 58, with a fit tolerance being only slightly greater than zero, such that the entire lowermost outer surface 583 of the second end 582 of ceramic filter 58 is seated in the annular groove of seating surface 534 and surrounded by the axially extending (e.g., vertically as shown) sidewall of shoulder portion 535 that defines the outer diameter of the annular groove. As with the ceramic filter assemblies described above, it is preferred that an adhesive is interposed at the joining surfaces of ceramic filter 58 and the ceramic housing tube 51, followed by a heat treatment, to secure the junction therebetween and maintain the integrity of that junction such that molten metal will not tend to seep through the junction or otherwise pass through the outlet 56 without first being properly filtered.

End cap 59 positioned over the first end 581 of ceramic filter 58 substantially completely closes off access to the central portion 587 of ceramic filter 58. As shown, the lower outer surface 592 of end cap 59 includes an annular groove or circumferentially recessed portion formed about the outer periphery thereof. The annular groove is shown in FIG. 5 to extend a distance in the radial (lateral) direction that is substantially equal to, but preferably slightly greater than, the thickness (i.e., the distance between the outer surface 585 and the inner surface 586) of sidewall 584 with a fit tolerance of zero or slightly higher. The annular groove also defines a raised central portion having a diameter that is substantially equal to, but preferably slightly less than) the inner diameter of the central portion 587 (defined by the distance between opposed portions of the inner surface 586 of sidewall 584) with a fit tolerance of zero or slightly higher.

End cap 59 is preferably secured to the first end 581 of ceramic filter 58 by a simple clamping means (e.g., without an adhesive), and, as shown, end cap 59 is further held in place by virtue of axial securing pressure that is applied to mechanical stabilizing means 593 after ceramic filter assembly 50 is positioned within vessel 710 of molten metal processing apparatus 700 shown in FIGS. 6 and 7. In that manner, it can be permissible to forego providing adhesive at this junction and to instead simply apply an external clamping force (e.g., apply an axially downward pressure) to the mechanical stabilization member 593 of end cap 59, for example, by an externally applied spring loaded force or by another method to obtain and maintain sufficient compression required to hold the respective pieces together regardless of any thermal expansion differences. Further, it will be understood that, at the first end 52 of the ceramic housing tube 51, provisions are required to secure the stabilizing member 593 to maintain that compression force on the ceramic filter 588 against the inner surface of the second end 53 of the ceramic housing tube 5 1. For example, a suitable mechanical clamping means could be applied to the securing part 595 that is positioned at the first end 52 of the ceramic housing tube 51 and in contact with a portion (e.g., the uppermost end part) of the stabilizing member 593 shown in FIGS. 5-6. It should be noted that any suitable securing means can readily be applied, and that the securing means can also be combined with, or share a dual function as, stabilizing means to secure the ceramic filter assembly 50, 60 in place, for example, within a compartment 611, 711 of a molten metal containment vessel 710 as shown in FIGS. 6 and 7.

Once prepared, ceramic filter assembly 50, 60 is preheated to a temperature of about 1500° F. in an inert gas atmosphere, such as argon or nitrogen, that has been purged of oxygen. The type of inert gas used is not critical, and should be appropriately selected based upon the compositions of the components comprising the ceramic filter assembly, cost and availability considerations and the like. It should be noted that ceramic filter assemblies 10, 20 and 40 shown in FIGS. 1-4 are also preferably purged and preheated in a similar manner before being introduced into a molten metal processing apparatus. Once purged, it is important that oxygen is substantially prevented from re-entering the ceramic filter assembly during the preheating step, as well as during the interim between the preheating step and insertion into the molten metal bath. It is also important that the temperature of the ceramic filter assembly remains elevated when it is introduced into the molten metal bath within a molten metal processing vessel, such as the first compartment 611 of the molten metal vessel 610 shown in FIG. 6, for example.

In order to accomplish the above, the upper end of the ceramic filter assembly is preferably capped, and an end plug is optionally, but preferably, provided for the lower end of the filter assembly, to cover and substantially seal the open ends of the ceramic filter assembly. The upper end cap preferably includes means for receiving an inert gas connection to introduce the inert atmosphere into the ceramic filter assembly prior to the preheating treatment, as shown and described in more detail below in connection with FIG. 8.

If provided, the end plug can be inserted into the open bottom end of the ceramic filter assembly, or mechanically attached thereto by any suitable means, either before the assembly is brought to the preheating temperature. Any suitable plug member can be used to accomplish this goal of maintaining a substantially oxygen-free atmosphere and maintaining the heat of the preheated ceramic filter assembly. When used, the end plugs are removed immediately prior to introducing the ceramic filter assembly into the molten metal bath in the containment vessel of the molten metal processing apparatus. The ceramic filter assembly is then immersed in molten metal as quickly as possible to further prevent oxygen inclusion and heat loss and to ensure effective priming takes place.

FIG. 8 is a partial cross-sectional view of one example of a preheating furnace 800 that is used to purge oxygen from and then heat a ceramic filter assembly, such as ceramic filter assembly 10 shown, prior to installing the filter assembly 10 in a molten metal processing apparatus. Preheating furnace 800 includes a furnace wall 801 that surrounds an inner heating chamber 808. The inner surfaces of the furnace walls 801 are lined with a suitable insulation material 802, and heating elements 803 are positioned within the heating chamber 808 proximate the insulation, as shown. An opening 804 is provided in the upper portion of the furnace wall 801 and the corresponding insulation 802 through which the second end of the ceramic housing tube of the furnace assembly 10 extends. The fit between the outer sidewall surface of the ceramic housing tube and at least the inner surface of the insulation opening 804 should be sufficient to ensure that unwanted oxygen cannot substantially penetrate either the ceramic filter assembly 10 or the heating chamber 808 during the preheating step and that heat does not dissipate from the heating chamber 807.

An end cap 810 is positioned to cover and effectively seal the open first end of the ceramic housing tube that protrudes beyond the outer surface of the upper portion of the furnace wall 801. As shown in FIG. 8, a portion of the end cap 810 fits within the inner diameter of the central chamber of the ceramic housing tube, and another portion of the end cap 810 rests on a sealing member 807, such as a gasket or an o-ring, for example, positioned on a part of the first end of the ceramic housing tube, such as a terminal end flange, as shown. The cap 810 shown in FIG. 8 is effectively set and held in place by virtue of its weight, which is preferably significant enough to prevent dislodging or detachment during oxygen evacuation and preheating treatment of the ceramic filter assembly. The sealing member 807 on which the end cap is at least partially seated can be any member that sufficiently seals the junction and substantially prevents the desired inert atmosphere from escaping the system and/or mixing with oxygen.

A connection port 806 is inserted or otherwise coupled to an inlet 811 passing through a central portion of cap 810 such that the desired inert atmosphere, such as nitrogen or argon, for example, is introduced into the central chamber of the ceramic housing tube of the ceramic filter assembly via the inlet 811 in the cap 810. Before the preheating treatment, any oxygen that is present due to the normal atmosphere of the environment is evacuated from the heating chamber 808 of the furnace 800 and the ceramic filter assembly 10 positioned therein via an escape outlet 805 that passes through the insulation 802 and the furnace wall 801 in the bottom portion thereof. The evacuated oxygen atmosphere is replaced with a flow of the desired inert gas atmosphere that is introduced at a predetermined rate via the inlet 811, and which also escapes from the heating chamber 808 of the furnace 800 via the outlet 805. The outlet 805 is preferably plugged or otherwise closed-off with a valve downstream from the outlet 805 prior to the preheating treatment such that the inert gas is maintained at a low pressure, such as 11-13 inches of column water, within the ceramic filter assembly and the within the furnace 800 during the heating step.

After the ceramic filter assembly 10 is heated to the desired temperature, the ceramic filter assembly 10 can be removed from the furnace 800 (e.g., upwardly lifted out) and the second end of the ceramic housing tube, including the outlet, can be plugged with a stopper (not shown) that prevents any substantial oxygen penetration into the ceramic filter assembly 10 and that also helps to retain the heat of the preheated assembly. Immediately before molten metal is introduced into the ceramic filter assembly 10, or immediately before the ceramic filter assembly (such as assembly 20 of FIG. 2, for example) is inserted into a molten metal-filled containment vessel of a molten metal processing apparatus, the plug or stopper is removed and the filter assembly is quickly positioned. As the molten metal contacts and penetrates the ceramic filter in the filter assembly to prime the filter, the priming behavior is not interrupted or otherwise negatively effected by oxygen within the assembly, and particularly, within the pores (inlets) of the ceramic filter. After the ceramic filter of the filter assembly is fully immersed in molten metal, either by pouring molten metal down into the ceramic housing tube of the assembly or by assembly immersion, the cap 810 can be removed to be used with the furnace 800 in the purging and preheating of another ceramic filter assembly.

In another case, the plug or stopper can be provided to the ceramic filter assembly before the assembly is inserted into the furnace 800 for oxygen purging and preheating. In this case, it is preferred that the plug includes an outlet passage that is adapted to be changed from an open to a closed state, and which corresponds to the escape outlet 805. In that manner, the outlet passage of the plug communicates with the outlet 805 of the furnace during the purging, and can simply be sealed or otherwise closed off during the step of removing the heated ceramic filter assembly from the furnace. Such a plug can then be removed immediately before the ceramic filter assembly is introduced into the molten metal of the appropriate processing apparatus.

It should also be noted, however, that in some cases, proving a stopper to the second end of the ceramic filter assembly is purely optional. For example, after the insert gas source is disconnected from the port 806, the entire furnace unit 800 may be transported, via fork truck, for example, to a location proximate the molten metal processing apparatus just prior to insertion. The proximity of the furnace to the molten metal processing apparatus allows for a swift transfer while maintaining the heat and substantially oxygen-free state of the ceramic filter assembly.

While it is preferred that the ceramic filter assemblies are preheated in a substantially oxygen-free atmosphere prior to insertion into the molten metal in the vessel, it also should be noted that the ceramic filter assemblies according to the present invention are equally applicable in situations where the ceramic filter assembly is being installed in the first instance, that is, before the vessel is filled with molten metal. In that case, the ceramic filter assembly may not require preheating before being positioned within the first compartment of the vessel, but may instead require subsequent heating via a heater system to reach a suitable temperature before molten metal is introduced, along with the rest of the molten metal processing apparatus 700. It would be preferred, however, that this preheating is conducted without the presence of oxygen in the atmosphere to improve the priming behavior of the ceramic filters for the reasons described above.

A more common situation is likely to be one in which a preheated ceramic filter assembly 50,60, preferably purged of oxygen, is inserted as a replacement ceramic filter assembly so that the prior assembly can be maintenanced or disposed of. In that case, as mentioned above, it is important the location of inlets 55 in the sidewall 54 of ceramic housing tube 51 is such that inlets 55 will be submerged beneath molten metal level 618, 718 when ceramic filter assembly 50, 60 is immersed in the molten metal bath within vessel 610, 710, as shown in FIGS. 6 and 7. In that manner, contaminants and surface oxides, for example, that are contained within the molten metal bath proximate the surface 618, 718 representing the molten metal level will not be as readily introduced to the central chamber 57 of ceramic housing tube 51 or to ceramic filter 58 therewithin.

On the other hand, if inlets 55 were instead positioned more proximate the molten metal surface level 618, 718 when ceramic filter assembly 50, 60 is installed, the contaminants present at that surface level would be sucked into the inlets and subjected to filtering. While ceramic filter 58 would effectively remove the contaminants from the molten metal, the increased amount of contaminants contacting the filter in this manner would merely serve to increase the rate at which the filter becomes clogged, and decrease the useful life of the filter, thus necessitating more frequent replacements. In the present invention, however, when these contaminants are prevented from contacting the ceramic filter in the first place (e.g., by virtue of the inlet position with respect to the minimum molten metal level in the vessel), they do not tend to significantly interfere with the throughput of the molten metal processing apparatus according to the present invention by prematurely clogging the ceramic filter.

In addition, as ceramic filter assembly 50, 60 is installed in a vessel of a molten metal processing apparatus, such as vessel 610 shown in FIG. 6, the contour shape of the outer surface 531 of the second end 52 of ceramic housing tube 51 enables ceramic filter assembly 50 to be easily positioned with respect to a correspondingly contoured port surface 614 and porthole 616 in the vessel 610, even when vessel 610 contains at least some amount of molten metal. That is, although the installer may not be able to visually align the outlet of the ceramic filter assembly with the port seating surface 614 and porthole 616 of molten metal containment vessel 610 (and particularly within the first compartment 611 of vessel 610 as shown), ceramic filter assembly 50 can still be accurately and substantially vertically (e.g., axially) aligned above a target location and inserted into the bath. Even if the alignment of that target position is slightly askew, for example, within a tolerance of about 2 inches, or if the second end of ceramic filter assembly 50 otherwise laterally deviates from the target position at some point in the molten metal bath during insertion, the corresponding hemispherical contours will easily assume the correct alignment, somewhat like a ball and socket joint, for example, when these portions are brought into contact. The extra play available provides positioning flexibility and improved positioning tolerances, and essentially eliminates the need for time consuming and labor intensive precision positioning or vessel draining steps. The above-described complimentary seating arrangement thus enables an accurate and secure junction between the outlet of ceramic filter assembly 50 and porthole 616 and between the second end of ceramic housing tube 51 and the port seating surface 614.

While corresponding seating surfaces for a molten metal processing apparatus are not shown in detail in connection with the ceramic filter assemblies of FIGS. 1-4, it will be readily understood by those skilled in the art that similar considerations apply with respect to the complimentary shapes of the respective seating portions. That is, in cases where the ceramic housing tube is contoured, but not necessarily hemispherical, the corresponding seating surface in the processing apparatus should still conform to the above considerations to provide easy alignment and stable and secure joining upon installation.

In most situations, the replacement ceramic filter assembly 50, 60 is inserted downwardly (e.g., bottom-first or outlet-first), into vessel 610 which is filled with molten metal that contains some degree of unwanted contaminants, and at that time, a small amount of that molten metal containing those contaminants may actually make its way up into the central portion 587 of ceramic filter 58 of ceramic filter assembly 50, 60 via the outlet. The amount of contaminated metal admitted into the central portion 587, however, merely represents a fraction of the total amount of metal that ultimately passes through that ceramic filter assembly. For example, the amount of contaminated metal that escapes filtering in this manner may represent an extremely small proportion, in a range of less than 0.00001%, and is thus considered negligible, especially in view of the numerous benefits provided by the filter assembly and molten metal processing apparatus of the present invention.

Once positioned and seated, axial stabilization, for example via the application of an external pressure, such a clamping force is provided to the first end 51 of ceramic housing tube 51 of ceramic filter assembly 50 to securely lock the ceramic filter assembly in place within vessel 610. As mentioned above, it is important that the junction between the ceramic filter assembly and the port is substantially impervious to molten metal so that contaminated metal will not be able to seep past the junction and into the second compartment via the porthole without first being filtered by ceramic filter 58. Any suitable clamping mechanism can be used to achieve this stability, examples of which include, but are not limited to toggle clamps and bolted joints, as mentioned above.

After a period of time, whose actual length may vary and is dependent upon many factors such as, for example, production throughput volume, the particular contaminants, the type of molten metal being processed and type and/or characteristics of the ceramic filtering material, the ceramic filter may become clogged with trapped contaminants or other debris at least at the outer surface thereof. During normal process operations, molten metal level 618 is maintained in a equalized state between first compartment 611 and second compartment 612, such that H1=H2 (i.e., the molten metal level in both compartments is substantially equal). When the ceramic filter no longer produces a sufficient throughput, however, due to buildup or other filter blocking factors, the molten metal level in the second compartment 612 will drop and the equilibrium between molten metal levels in the first and second compartments will be diminished.

When the molten metal level in the end compartment reaches a critical minimum molten metal level, which is in a range of about 1 to 3 inches below the molten metal surface level in the preceding compartment (e.g., just upstream), steps are taken to remove the existing ceramic filter assembly 50 having the clogged ceramic filter 58, and to replace the clogged ceramic filter assembly with a new, preheated ceramic filter assembly. First, the consumption of molten metal from the second compartment 612 is interrupted so that the molten metal levels in the two compartments can establish a new equilibrium. Once equalized, the clamping mechanism or other stabilizing means is released. As the old ceramic filter assembly 50, 60 is removed from the molten metal bath, yet unfiltered molten metal within the central chamber 57 of ceramic housing tube 51, and filtered molten metal present in the central portion 587 of ceramic filter 58, drain back into the first compartment 611.

After the clogged ceramic filter assembly 60 is removed, the molten metal level in the fist compartment 611 will be slightly less than the molten metal level in the second compartment 612 due to the prior volumetric displacement provided by the now-removed ceramic filter assembly 50, 60. In this case, a small amount of filtered molten metal that is present in the second compartment 612 may, by virtue of the pressure relationship between the first and second compartments, tend flow back through the porthole 616 and into the first compartment 611 in an effort to establish an equalized state, whereas the yet unfiltered molten metal, and even the filtered molten metal, present in the first compartment 611 will not tend to flow toward the second compartment. This behavior is not considered detrimental to the process since the metal flowing into the first compartment 611 has already been filtered, and will be filtered again once a new ceramic filter assembly 60 is provided and the process resumed.

Either before or after, but preferably before, a new equalized state is achieved between the first and second compartments, a replacement ceramic filter assembly 60 is installed in the vessel 610 in the manner described above. Thereafter, the process is resumed with only a minimal interruption to account for the equalization times and actual ceramic filter assembly replacement.

FIG. 7 is a partial cross-sectional view of another molten metal processing apparatus according to this embodiment of the present invention and including ceramic filter assemblies 50, 60 shown in FIGS. 5 and 6. Like vessel 610 shown and described in connection with FIG. 6, vessel 710 of apparatus 700 in FIG. 7 includes a first compartment 711 that is separated from second compartment 712, at least in part, by barrier wall 713 that includes port 714 and porthole 716 and in part by ceramic filter assembly 60 (or 50) seated thereon, such that porthole 716 is in communication with the outlet of the ceramic filter assembly 50 (or 60), when installed, and is in communication with the first compartment 711 when a ceramic filter assembly is not installed, e.g., during the replacement process. Barrier wall 713 includes an outlet 713B in communication with second compartment 712 and also defines a third compartment 713A that separates the first and second compartments 711, 712. As shown, the third compartment 713A houses a degassing system 717, such as a bubbler unit as shown in FIG. 7. Any suitable degassing system can be used in apparatus 700, and it should be noted that the degasser can also be positioned upstream from the ceramic filter assembly within the molten metal processing apparatus 700.

Apparatus 700 also includes a first heater 719 positioned within the first compartment 711, upstream from the filter assembly 60 (or 50) and a second heater 720 positioned within the second compartment 712 downstream from filter assembly 60 (or 50) and bubbler 717. Heaters 711 and 712 are preferably set to maintain the temperature of the molten metal present in the respective compartments to be in range that provides optimal molten metal flow characteristics (e.g., viscosity, consistency, etc.) in order to improve the process throughput, speed and overall efficiency. In the case of molten aluminum processes, it is preferred that the heaters maintain the molten metal to be in a temperature range of 1250 to 1400° F., and more preferably, in a range of 1275 to 1350° F., but this range may vary depending upon the actual melting point of the particular molten alloy application.

Any known heater can be employed in apparatus 700, it is preferred that the heaters 719, 720 be made of a material that is chemically resistant to high temperature molten metal and that has excellent thermal conductivity.

It should also be noted that additional heaters could also be provided in apparatus 700 or in a similar molten metal processing apparatus having a varied structure, as dictated by the specific system requirements on an application dependent basis. When a degasser is provided, however, it is preferred to include at least one heater, downstream from and proximate the degasser, in order to compensate for any molten metal temperatures losses that may be associated with the degassing processes. In that manner, the filtered and degassed molten metal in the second compartment 712 can be maintained at the optimal temperature despite the several process operations to which that molten metal has been subjected.

While the present invention has been shown and described above with reference to specific examples, it should be understood by those skilled in the art that the present invention is in no way limited to these examples, and that variations and modifications can readily be made thereto without departing from the scope and spirit of the present invention.

1. An interchangeable ceramic filter assembly for filtering molten metal, comprising:
a ceramic housing tube having a first end, an opposed second end, a sidewall connecting said first and second ends, at least one inlet, and an outlet, said sidewall having an outer surface defining an outer peripheral dimension of said ceramic housing tube and an inner surface defining an inner peripheral dimension of said ceramic housing tube and further defining a central chamber of said ceramic housing tube; and
a ceramic filter positioned within said ceramic housing tube and providing a barrier between said inlet and said outlet of said ceramic housing tube, said ceramic filter having a first end, an opposed second end, a sidewall connecting said first and second ends, an inlet at least on a portion of said sidewall, and an outlet, said sidewall having an outer surface defining an outer peripheral dimension of said ceramic filter and facing said inner surface of said ceramic housing tube, and an inner surface defining an inner peripheral dimension of said ceramic filter and further defining a central portion of said ceramic filter, said outer surface of said ceramic filter being spaced from said inner surface of said ceramic housing tube by a distance D;
wherein said outlet of said ceramic filter is substantially coaxially aligned with said outlet of said ceramic housing tube; and
wherein molten metal present at said outlet of said ceramic housing tube has a contaminant concentration that is less than a contaminant concentration of molten metal present at said inlet of said ceramic housing tube.

2. The ceramic filter assembly of claim 1, wherein said at least one inlet of said ceramic housing tube is positioned proximate said first end thereof.

3. The ceramic filter assembly of claim 1, wherein when said ceramic filter assembly is positioned within a molten metal containment vessel, said at least one inlet of said ceramic housing tube is positioned on a portion of said sidewall thereof at a location that is lower than a molten metal surface level within said molten metal containment vessel such that said molten metal surface level is between said at least one inlet and said first end of said ceramic housing tube.

4. The ceramic filter assembly of claim 1, wherein an inner surface of said second end of said ceramic housing tube comprises a seating surface in contact with one of said outer surface of said ceramic filter sidewall proximate said second end thereof and an end surface of said second end of said ceramic filter.

5. The ceramic filter assembly of claim 4, wherein said seating surface further comprises a shoulder portion.

6. The ceramic filter assembly of claim 1, wherein said outer surface of said second end of said ceramic housing tube has a contour shape proximate said outlet.

7. The ceramic filter assembly of claim 6, wherein said contour shape is at least substantially hemispherical.

8. The ceramic filter assembly of claim 1, wherein said ceramic filter further comprises an inlet on at least a portion of said first end thereof.

9. The ceramic filter assembly of claim 1, wherein said ceramic filter comprises a first end cap fastened to said first end of said ceramic filter and a second end cap fastened to said second end of said ceramic filter, said first end cap comprising means for mechanically stabilizing said ceramic filter within said ceramic housing tube and said second end cap comprising an opening coaxially aligned with said outlet of said ceramic filter and said outlet of said ceramic housing tube.

10. A molten metal processing apparatus comprising:
a molten metal containment vessel adapted to maintain a quantity of molten metal at least at a minimum molten metal surface level, said vessel including at least a first compartment and a second compartment that is separated from said first compartment; and
an interchangeable ceramic filter assembly separating at least a portion of said first and said second compartments of said vessel, said interchangeable ceramic filter assembly comprising
a ceramic housing tube having a first end, an opposed second end, a sidewall connecting said first and second ends, at least one inlet, and an outlet, said sidewall having an outer surface defining an outer peripheral dimension of said ceramic housing tube and an inner surface defining an inner peripheral dimension of said ceramic housing tube and further defining a central chamber of said ceramic housing tube, and
a ceramic filter positioned within said ceramic housing tube and providing a barrier between said inlet and said outlet of said ceramic housing tube, said ceramic filter having a first end, an opposed second end, a sidewall connecting said first and second ends, an inlet at least on a portion of said sidewall, and an outlet, said sidewall having an outer surface defining an outer peripheral dimension of said ceramic filter and facing said inner surface of said ceramic housing tube, and an inner surface defining an inner peripheral dimension of said ceramic filter and further defining a central portion of said ceramic filter, said outer surface of said ceramic filter being spaced from said inner surface of said ceramic housing tube by a distance D, and said outlet of said ceramic filter being substantially coaxially aligned with said outlet of said ceramic housing tube;
wherein said inlet of said ceramic housing tube is in fluid communication with said first compartment, and said outlet of said ceramic housing tube is in fluid communication with said second compartment at least via a porthole provided in a port located between said first and said second compartments; and
wherein a molten metal contaminant concentration in said second compartment is less than a molten metal contamination concentration in said first compartment.

11. The apparatus of claim 10, wherein said port between said first and said second compartments of said vessel comprises a seating surface proximate said porthole, said port seating surface having a contour that is complementary to a surface contour of an outer surface of said second end of said ceramic housing tube proximate said outlet.

12. The apparatus of claim 10, further comprising means for mechanically stabilizing said filter assembly within said vessel.

13. The apparatus of claim 10, wherein said at least one inlet of said ceramic housing tube is positioned on a portion of said sidewall thereof at a location that is lower than said minimum molten metal level such that said minimum molten level is between said at least one inlet and said first end of said ceramic housing tube of said filter assembly.

14. The apparatus of claim 10, wherein an inner surface of said second end of said ceramic housing tube comprises an inner seating surface in contact with at least one of said outer surface of said ceramic filter sidewall proximate said second end thereof and an end surface of said second end of said ceramic filter.

15. The apparatus of claim 14, wherein said inner seating surface comprises a shoulder portion.

16. The apparatus of claim 10, wherein said outer surface of said second end of said ceramic housing tube has a contour shape proximate said outlet.

17. The apparatus of claim 16, wherein said contour shape is at least substantially hemispherical.

18. The apparatus of claim 10, wherein said ceramic filter further comprises an inlet at least on a portion of said first end thereof.

19. The apparatus of claim 10, wherein said ceramic filter of said ceramic filter assembly comprises at least one of a first end cap fastened to said first end of said ceramic filter and a second end cap fastened to said second end of said ceramic filter, wherein said first end cap comprises means for mechanically stabilizing at least one of (i) said ceramic filter within said ceramic housing tube and (ii) said filter assembly within said vessel, and wherein said second end cap comprises an opening coaxially aligned with said outlet of said ceramic filter and said outlet of said ceramic housing tube.

20. A method for determining a replacement time and for replacing an interchangeable ceramic filter assembly in a molten metal processing apparatus, said method comprising the steps of:
providing a first interchangeable ceramic filter assembly comprising
a ceramic housing tube having a first end, an opposed second end, a sidewall connecting said first and second ends, at least one inlet, and an outlet, said sidewall having an outer surface defining an outer peripheral dimension of said ceramic housing tube and an inner surface defining an inner peripheral dimension of said ceramic housing tube and further defining a central chamber of said ceramic housing tube, and
a ceramic filter positioned within said ceramic housing tube and providing a barrier between said inlet and said outlet of said ceramic housing tube, said ceramic filter having a first end, an opposed second end, a sidewall connecting said first and second ends, an inlet at least on a portion of said sidewall, and an outlet, said sidewall having an outer surface defining an outer peripheral dimension of said ceramic filter and facing said inner surface of said ceramic housing tube, and an inner surface defining an inner peripheral dimension of said ceramic filter and further defining a central portion of said ceramic filter, said outer surface of said ceramic filter being spaced from said inner surface of said ceramic housing tube by a distance D,
wherein said outlet of said ceramic filter is substantially coaxially aligned with said outlet of said ceramic housing tube, and wherein molten metal present at said outlet of said ceramic housing tube has a contaminant concentration that is less than a contaminant concentration of molten metal present at said inlet of said ceramic housing tube,
said first ceramic filter assembly being positioned in a molten metal containment vessel of a molten metal processing apparatus such that said first ceramic filter assembly separates at least a portion of a first compartment of said vessel from a second compartment of said vessel such that said inlet of said ceramic housing tube is in fluid communication with said first compartment and such that said outlet of said ceramic housing tube is in fluid communication with said second compartment at least via a porthole provided in a port between said first and said second compartments;
monitoring a molten metal level within said first and said second compartments of said vessel as molten metal in said second compartment is consumed and replenished with molten metal from said first compartment via said first ceramic filter assembly;
determining that said molten metal level in said first compartment exceeds said molten metal level in said second compartment by a predetermined amount;
interrupting consumption of said molten metal from said second compartment and allowing said molten metal level in said second compartment to equalize with said molten metal level in said first compartment;
removing said first ceramic filter assembly from said vessel;
providing a second ceramic filter assembly having a structure that is at least substantially the same as said first ceramic filter assembly and that has been pre-heated to a predetermined temperature in an inert gas atmosphere;
positioning said second ceramic filter assembly in said vessel such that said outlet of said ceramic housing tube of said second ceramic filter is substantially aligned with and in fluid communication with said porthole of said port;
priming said ceramic filter; and
resuming consumption of said molten metal in said second compartment as said molten metal is replenished with molten metal from said first compartment via said second ceramic filter assembly.
